(19) United States
(12) Patent Application Publication
(10) Pub. No.: US 2004/0033474 A1
(43) Pub. Date: Feb. 19, 2004

(54) Method and system for quick reading practice using internet

(76) Inventor: Kyu Jin Park, Kyungki-do (KR)

Correspondence Address: Warner Norcross & Judd, Intellectual Property Practice Group, 900 Fifth Third Center, 111 Lyon Street N W, Grand Rapids, MI, 49503-2487, US

(21) Appl. No.: 10/332,404

(22) PCT Filed: Jul. 12, 2001
(86) PCT No.: PCT/KR01/01197

(30) Foreign Application Priority Data
Jul. 12, 2000 (KR) 2000/39867

(51) Int. Cl. G09B 17/04

(52) U.S. Cl. 434/179

(57) ABSTRACT

A method and a system for a quick reading training using the Internet are disclosed, in which diversified training data for the quick reading are provided through the Internet, and the results of the quick reading training are tested on the real time basis, so that the fast reading ability and the trainee's progress in the quick reading training can be known. The method for a quick reading training using the Internet includes the following steps. That is, one of the connectable terminals is connected by a fast reading trainee to the server to make the server transmit a fast reading menu picture data to the connectable terminal (first step). The fast reading menu picture is outputted onto the terminal, and a fast reading training mode and fast reading training conditions are selected by the fast reading trainee to receive them (second step). The fast reading training data is outputted to the connectable terminal of the fast reading trainee to make the fasting reading trainee carry out the fast reading training based on the fast reading training mode and the fast reading training conditions as selected by the fast reading trainee (third step). Further, a test mode is included, so that the trainee can test his or her own fast reading ability prior to the training.

### FIELD OF THE INVENTION

The present invention relates to a method and a system for a quick reading training using the Internet, and to a storing medium for storing a program for carrying out the quick reading training. More specifically, the present invention relates to a method and a system for a quick reading training using the Internet, in which diversified training data for the quick reading are provided through the Internet, and the results of the quick reading training are tested on the real time basis, so that the progress in the quick reading training can be known.

### BACK GROUND OF THE INVENTION

The quick reading is based on the interline motions of the eyeballs, so that the contents of a book can be understood in a quick and accurate manner. That is, such ability is grown, so that a large amount of book contents can be read within a relatively short period of time. Accordingly, this method is mostly applied to the examination-preparing students.

Conventionally, in order to train the quick reading, the eyeballs are moved up, down, left and right along printed letters or designs (printed on a paper), while adjusting the eyeball motions and repeating the eyeball motions. Thus the motions of the eyeballs are promoted, and thus the fast reading ability is promoted.

However, it the conventional fast reading method, the training has been too simple and tedious, and therefore, many trainees have been dropped out in the mid course, with the result that the training has become utterly inefficient. The renouncing of the trainees was caused by the following reasons. That is, the repeated same letters and designs are tedious, and the trainees have to carry with the paper texts. Further, the letters and designs which are used in the fast reading training are continuously repeated, and therefore, the reading lines are lost during the reading due to the optical illusion, with the result that the trainees are discouraged in going through the training.

### SUMMARY OF THE INVENTION

The present invention is intended to overcome the above described disadvantages of the conventional technique.

Therefore it is an object of the present invention to provide a fast reading training method using the Internet, and a system for it, in which diversified training data for the quick reading are provided through the Internet, and the results of the quick reading training are tested on the real time basis, so that the progress in the quick reading training can be known by the trainees.

It is another object of the present invention to provide a fast reading test method and a fast reading training method, in which the fast reading training can be carried out on an offline basis.

In achieving the above objects, the fast reading training method using the Internet with a plurality of connectable terminals and one or more servers for providing services in response to the connectable terminals according to the present invention includes the steps of: connecting one of the connectable terminals by a fast reading trainee to the server to make the server transmit a fast reading menu picture data to the connectable terminal (first step); outputting the fast reading menu picture onto a screen of the terminal, and selecting a fast reading training mode and the fast reading training conditions by the fast reading trainee to receive them (second step); and outputting the fast reading training data to the connectable terminal of the fast reading trainee to make the fasting reading trainee carry out the fast reading training based on the fast reading training mode and the fast reading training conditions as selected by the fast reading trainee (third step).

In another aspect of the present invention, the fast reading training system according to the present invention includes: a wire communication module 51 for data transmission and reception through a wire Internet; a control module 52 for processing the requests of connectable terminals upon receipt of them through the wire communication module 51, and for transmitting the processed data to the connectable terminals, with a control program being stored therein; a wireless communication module 56 for data transmission and reception through a wireless Internet; a gateway 54 for converting the signals from the wireless communication module 56 and the signals from the control module 52 into wireless Internet formats respectively; a fast reading training DB 53 for storing motion pictures, images and character data, and for outputting them upon requests by the control module 52; and a subscriber DB 55 for storing a set of private information including the fast reading training information on the connected users.

### BRIEF DESCRIPTION OF THE DRAWINGS

The above objects and other advantages of the present invent ion will become more apparent by describing in detail the preferred embodiment of the present invention with reference to the attached drawings in which:

FIG. 1 is a schematic view showing the connection status of the Internet communication network of the conventional technique;

FIG. 2 is a flow chart showing the constitution of the fast reading training method according to the present invention;

FIG. 3 is a block diagram showing the constitution of the fast reading training system according to the present invention; and

FIGS. 4 to 6 illustrate the output status in the fast reading training method according to the present invention.

*Names of elements

| | |
|---|---|
| 10, 20 and 30: client PC | 40: portable communication terminal |
| 50: server | 51: wire communication module |
| 52: control module | 53: fast reading training DB |
| 54: gateway | 55: subscriber DB |
| 56: wireless communication | |
| module | |

### DETAILED DESCRIPTION OF THE PREFERRED EMBODIMENT

Now the fast reading training method and its system according to the present invention will be described referring to the attached drawings.

In the present invention, a training data for the fast reading training is provided through the Internet, and the result of the fast reading training is tested on the real time basis, so that the improvement of the fast reading ability can be known instantly by the trainee. That is, the fast reading data such as letters, images and motion pictures are displayed on a display device such as LCD, TFT-LCD or a monitor. That is, the present invention can be embodied through a personal computer (PC), a wireless Internet terminal, an electronic book, a digital caption player, a PDA, a hand phone, a PCS or the like.

Particularly in the case of the electronic book, the fast reading training data is stored into the internal memory or into another non-volatile storing means, so that the data can be executed. If a proper wireless communication means is utilized, the fast reading training data can be periodically updated by connecting to the server, so that an improved data can be used in carrying out the fast reading training.

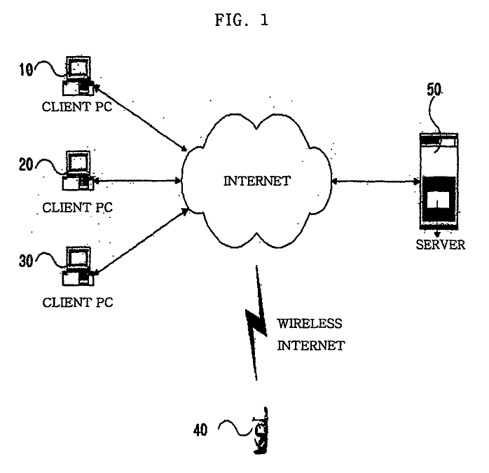

Now the operation of the server 50 will be described by referring to FIG. 1.

A user connects his or her client PC (10, 20 or 30) through the normal Internet communication network (including the wire or wireless Internet) to the server 50, and requests for a transmission of a fast reading training data. Then the server which has received such a request transmits the fast reading training data in accordance with the request of the user.

Under this condition, if the client PC is connected to the server, the server transmits a normal web content data based on HTML or XML. On the other hand, if a portable terminal using the wireless Internet protocol is connected, then the contents are converted based on the protocol such as WAP or ME by utilizing the gateway, and the processed contents are outputted so that the contents can be used by a wireless communication terminal. The gateway will be described later. The portable terminal 40 may be anyone selected from among a hand phone, PCS, PDA and IMP2000 in which the wireless Internet protocol is stored.

The fast reading training can be carried out in various ways. For example, in the case of letters, the characters are outputted one by one, and motions of the eyeballs are made performed in a prepared manner based on the fast reading training pattern. Or the motions of the eyeballs are induced by utilizing the motion pictures. By adjusting the speed of the outputting of the letters or motion pictures, the progress of the fast reading education can be adjusted in accordance with the fast reading ability of the trainee. The preparation of the fast reading training data can be done in various other manners, if they are effective in training the eyeball motions.

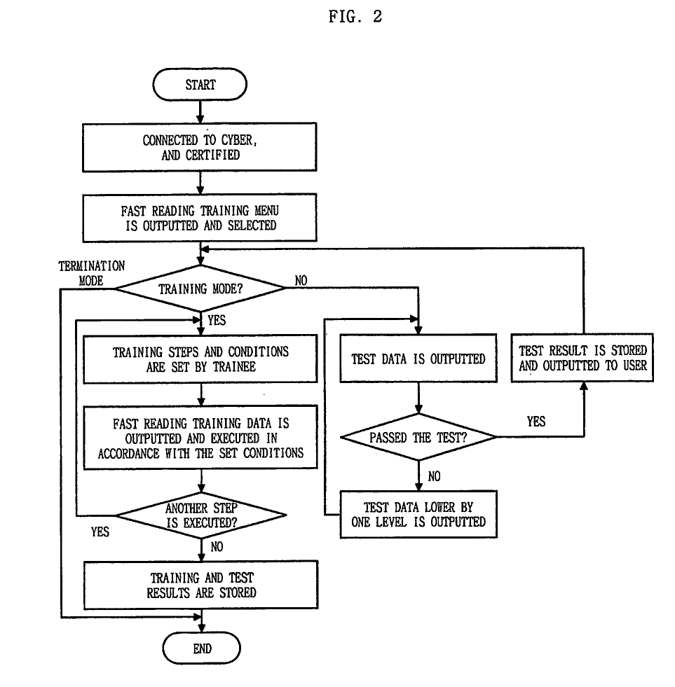

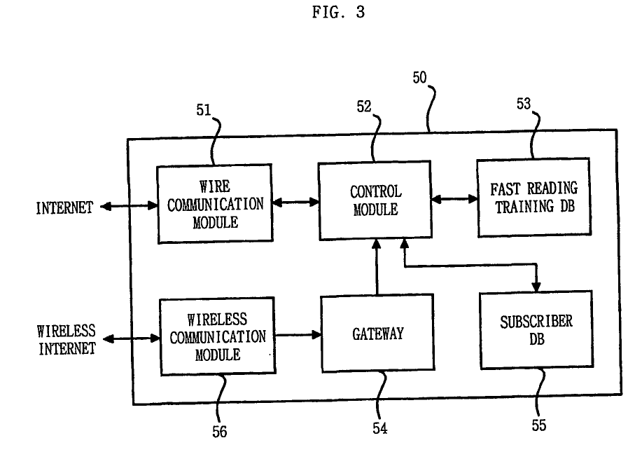

FIGS. 2 and 3 illustrate the constitutions of the fast reading training method and its system according to the present invention. The fast reading training method according to the present invention includes the steps of: connecting one of the connectable terminals by a fast reading trainee to the server to make the server transmit a fast reading menu picture data to the connectable terminal (first step); outputting the fast reading menu picture onto the screen of the terminal, and selecting a fast reading training mode and fast reading training conditions by the fast reading trainee to receive them (second step); and outputting the fast reading training data to the connectable terminal of the fast reading trainee to make the fasting reading trainee carry out the fast reading training based on the fast reading training mode and the fast reading training conditions as selected by the fast reading trainee (third step).

At the first step, the user connects his or her Internet connection apparatus (such as client PC, PCS, PDA, hand phone or IMT2000) to the server 50. After the connection to the server, if the user receives a subscriber certification (including the items to be selected), then the server 50 transmits a data of the menu picture for the fast reading training to the communication device of the connected terminal.

It is assumed that the user has connected his or her client PC 10 to the server 50 for the sake of the describing convenience. In this case, the fast reading menu picture is displayed through a web browser such as nescape or navigator.

In the case where the connection to the server 50 is made through a portable terminal 40, the display is made in the same manner. However, a difference lies in whether the outputted data is converted or not (in the case of the wireless Internet). Actually, the conversions of the transmission data and the reception data are done at the gateway based on the wireless Internet protocol (WAP, MS mobile, explorer, s-html).

The trainee can select the desired fast reading training conditions from the fast reading menu picture, and this corresponds to the second step of the method of the present invention.

The fast reading training menu includes: the training modes and the training mode conditions. It can further include: a test mode for testing the current fast reading ability of the trainee; and a termination mode for terminating the connection with the server.

The training mode is for executing a program for the fast reading training. The test mode is for measuring the fast reading ability of the user so as to make it possible to decide a proper training level (training step) at the training mode.

An initial setup status consists of a menu in which the fast reading trainee basically selects the training mode and the training mode conditions. Thus the server 50 outputs the menu for the fast reading training mode. The user reviews the menu, and selects proper items which are suitable for his or her fast reading ability.

The level of the fast reading training mode includes various training procedures of diversified patterns. For example, variations are assigned to the output status of letters, images and motion pictures, and to the outputting speed, character display status, motion picture display status and the like. Under this condition, the mentioned statuses should be aimed at promoting the motions of the eyeballs. The examples of the character display which can be executed during the fast reading training procedure can be cited as follows.

1. In the case of writing the characters in the lateral direction, if the lines are written from above to below one line by one line in the longitudinal direction, the lines are outputted starting from the left side one by one.

2. In the case of writing the characters in the lateral direction, if the lines are written from above to below one line by one line in the longitudinal direction, the lines are outputted starting from the right side one by one, and the preceding line is deleted.

3. In the case of writing the characters in the lateral direction, if the lines are written from above to below one line by one line in the longitudinal direction, the lines are outputted starting from the right side one by one, and the preceding line is reversed.

4. In the case of writing the characters in the lateral direction, if the characters are written from above to below one character by one character in the longitudinal direction, the characters are outputted starting from the right side one by one, and the preceding line is deleted.

5. In the case of writing the characters in the lateral direction, if the characters are written from above to below one character by one character in the longitudinal direction, the characters are outputted starting from the right side one by one, and the preceding line is reversed.

6. In the case of writing the characters in the lateral direction, one whole page is outputted, and in the case of a lateral writing, the writing is done from above to below, while in the case of a longitudinal writing, the lines are deleted starting from the right sequentially.

7. In the case of displaying the characters in the lateral direction, one whole page is outputted, and in the case of a lateral writing, the writing of lines is done from above to below, while in the case of a longitudinal writing, the lines are reversed starting from the right sequentially.

8. In the case of displaying the characters in the lateral direction, one whole page is outputted, and in the case of a lateral writing, the writing of characters is done from above to below, while in the case of a longitudinal writing, the characters are deleted starting from the right sequentially.

9. In the case of displaying the characters in the lateral direction, one whole page is outputted, and in the case of a lateral writing, the writing of characters is done from above to below, while in the case of a longitudinal writing, the characters are reversed starting from the right sequentially.

10. In the case of displaying the characters in the lateral direction, one whole page is outputted, and after elapsing of some time period, the total page is deleted at one time.

In the display method of the fast reading training modes, there can be adopted other methods. For example, particular character streams can be sequentially displayed in such a manner that the motions of the eyeballs can flow the displaying. All such variations should come within the scope of the present invention.

Further, in addition to making the characters displayed, reversed, deleted and blinked to induce the motions of the eyeballs, there can be used the images. That is, the images can be sequentially outputted, reversed, deleted and blinked so as to induce the motions of the eyeballs. Meanwhile, in the case of motion pictures, particular motions of the motion pictures can be outputted for a certain period of time so as to induce the motions of the eyeballs.

The condition setup for the fast reading training modes can be as follows. That is, the outputting method, the speed, the number of times, the time interval and the like are set up for characters, images and motion pictures, so that diversified motions of the eyeballs can be induced.

The method of the present invention can further include a test mode. That is, when selecting the conditions for the fast reading training modes, the user should desirably know his or her own fast reading ability. However, if the user does not know his or her fast reading ability, the provision of a test mode is needed so that the fast reading ability of the user can be measured.

FIG. 2 illustrates such that the fast reading training modes and the test mode can be selected at the mode selecting step. Here, the selection symbol (diamond shape) and the test mode can be apparently split into separate procedures.

If the test mode is selected, a fast reading test data is outputted from the server 50. For example, in the test mode, (a) a particular training data (e.g., one page of character data, images or motion pictures) is presented within a limited time, (b) the training data understanding level is measured (correct answer on a plurality of questions are evaluated), (c) if the user comes short of a certain required level, then the shifting time for the training data or the particular training data display time is increased, (d) the item c is repeated until the user reaches the required level, and (e) the fast reading ability of the user is assessed. Thus after accurately judging on the fast reading ability of the user, the training mode is selected to carry out the fast reading training.

The test mode is for evaluating the fast reading ability of the user. The fast reading program is outputted not by the selection of the user, but it is outputted based on the predetermined conditions. The fast reading trainee executes the fast reading test program, and transmits the test results to the server 50, so that the fast reading ability of the user can be accurately measured. In the above, the fast reading ability was tested based on the character data, but images and motion pictures can also be used in testing the fast reading ability of the user.

For example, in the case of images, images are outputted sequentially or randomly, and questions are presented on the contents of the images, so that the understanding of the contents by the trainee can be measured. This can also be applied to the motion pictures in a similar manner. The fast reading ability can be tested by varying the output time period of the images.

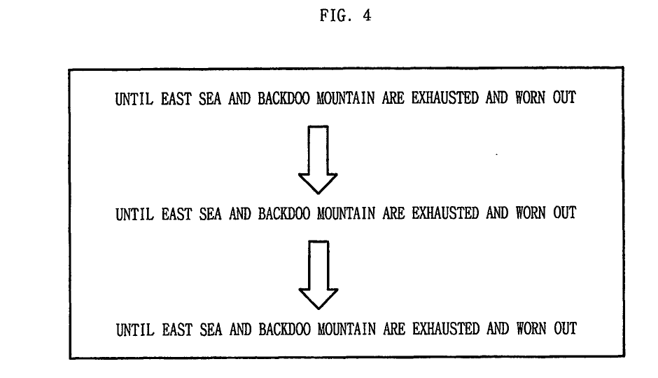

FIGS. 4 to 6 illustrate the examples of the execution of the fast reading training under the fast reading training mode or under the fast reading ability testing mode.

FIG. 4 illustrates a state in which one page or one line of characters is displayed, and in this state, the first character is deleted to move to the next position. The user follows the characters (thus being deleted), so that his or her eyeballs can move in a natural manner, thereby training the motions of the eyeballs. The fast reading trainee can adjust the time gap by which the characters are deleted, thereby increasing or decreasing the training speed.

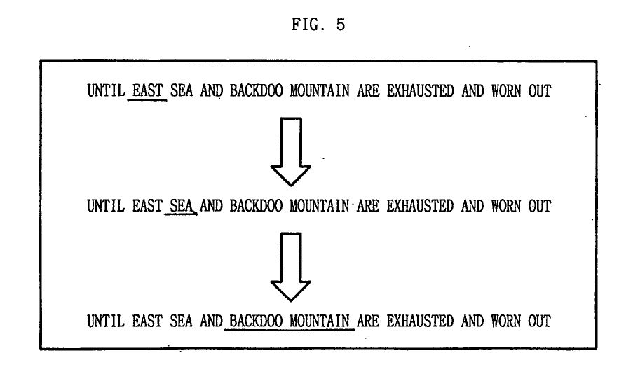

FIG. 5 illustrates a status in which one line of characters is displayed, and in this state, each of the characters is sequentially underlined and un-underlined. The user follows the underlined characters, so that his or her eyeballs can be moved in a natural manner, thereby training the motions of the eyeballs. Further, the user can adjust the time gap by which the characters are sequentially underlined and un-underlined, thereby increasing or decreasing the training speed.

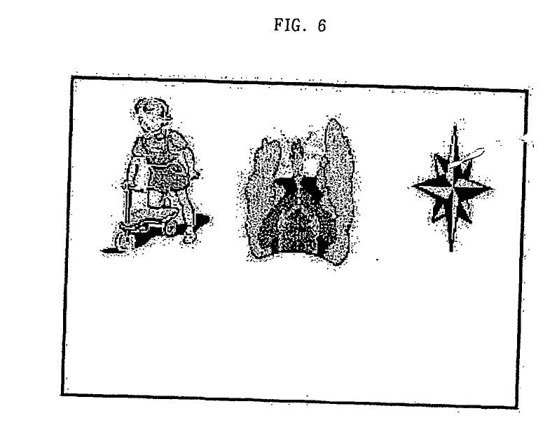

FIG. 6 illustrates a status in which a plurality of images make appearance and disappearance in a sequential manner. Conventionally, there has been only the character training, but in the present invention, image training is introduced. Thus the motions of the eyeballs can be trained in a natural manner.

In the present invention, the eyeball training patterns can be applied not only to those of FIGS. 4 to 6, but also to the items 1˜10 above. That is, to the characters, images and motion pictures of the items 1˜10. All of these should come into the scope of the present invention.

FIG. 3 illustrates the fast reading training system according to the present invention.

As shown in this drawing, the fast reading training system according to the present invention includes: a wire communication module 51 for data transmission and reception through a wire Internet; a control module 52 for processing the requests of connectable terminals upon receipt of them through the wire communication module 51, and for transmitting the processed data to the connectable terminals, with a control program being stored the control module 52; a wireless communication module 56 for data transmission and reception through a wireless Internet; a gateway 54 for converting the signals from the wireless communication module 56 and the signals from the control module 52 into wireless Internet formats respectively; a fast reading training DB 53 for storing motion pictures, images and character data, and for outputting them upon requests by the control module 52; and a subscriber DB 55 for storing a set of private information including the fast reading training information on the connected users.

The wire communication module 51 is for carrying out data transmission and reception to and from a communication terminal such as a client PC through a wire Internet.

The data which is inputted through the wire communication module 51 is directly supplied into the control module 52. The control module 52 processes the received data based on its nature, and then sends back the processed data through the wire communication module 51 to the client PC 10.

On the other hand, in the case where a connection is made through a wireless Internet, the signals are demodulated by the wireless communication module 56, and then the Internet format is converted by the gateway 54. That is, WAP which is a wireless Internet format is converted to the HTML format by the gateway 54. The data which has been converted by the gateway 54 is inputted into the control module 52 to be processed by it. The processed result is outputted after being converted by the gateway 54. That is, the gateway 54 converts the HTML data of the server 50 to a data of the wireless Internet protocol (WAP, and ME).

The present invention can be applied not only to the above described communication connection terminals, but also to a letter and audio reproducing apparatus such as caption digital player. That is, in this apparatus, the present invention can be carried out by adjusting the character data conditions (underline, deletion, blinking or outputting speed). In the case of the digital caption player, there has to be equipped with a separate data transmission reception apparatus to be connected to the client PC, thereby transmitting or receiving the data. Alternatively, the required data file is downloaded, and this data can be played by the caption digital player.

The control module 52 contains a control program for controlling the server 50, and for processing the data in accordance with the request of the user.

The fast reading training DB stores the fast reading training data such as character data, image data and motion picture data. These data can be updated by receiving new contents from the outside. Accordingly, the manager can store the data into the fast reading training DB 53 at a remote place. The subscriber DB 55 stores the private information on the connected users, and stores various sets of information on the fast reading training procedure. The fast reading training DB 53 and the subscriber DB 55 may consist of any one of a fresh memory, a hard disk, MO, and a rewritable DC.

In the above described present invention, it was described that wire and wireless Internets were mixedly used. But it is apparent that they also can be separately and independently used in carrying out the present invent ion. That is, one server can make the wire communication module 51 process the data which is inputted through the wire Internet. Another server can make the wireless communication module 56 and the gateway 53 process the data which is inputted from a wireless communication terminal. In this case, the task is divided into two parts, so that a stable servicing can be possible.

Thus, in the present invention, it is apparent that the operating programs can be installed in an independent double form, so that the present invention can be carried out at an offline position. This variation should also come into the scope of the present invention. In other words, the user can download an offline program to judge on his or her own fast reading ability, and then, the user can connect his or her PC or the like to the server 40 in an online basis so as to carry out the training mode.

For example, the fast reading training mode and the test mode are formed into separate program respectively, and the executions of the programs can be separately carried out from each other, thereby carrying out the fast reading training. Further, a storing medium, which stores the programs for carrying out the fast reading training method and the test mode, should come into the scope of the present invention.

Industrial Applicability

According to the present invention as described above, the learning data for carrying out the fast reading training is provided through the Internet, and the training result is tested on the real time basis, so that the trainee can know the improvements of his or her fast reading ability.

In the above, the present invention was described based on the specific preferred embodiments and the attached drawings, but it should be apparent to those ordinarily skilled in the art that various changes and modifications can be added without departing from the spirit and scope of the present invention, which will be defined in the appended claims.

What is claimed is:

1. A fast reading training method using the Internet with a plurality of connectable terminals and one or more servers for providing services in response to the connectable terminals, comprising the steps of:
connecting one of the connectable terminals by a fast reading trainee to the server to make the server transmit a fast reading menu picture data to the connectable terminal (first step);
outputting the fast reading menu picture onto a screen of the terminal, and selecting a fast reading training mode and fast reading training conditions by the fast reading trainee (second step); and
outputting the fast reading training data to the connectable terminal of the fast reading trainee to make the fasting reading trainee carry out the fast reading training based on the fast reading training mode and the fast reading training conditions as selected by the fast reading trainee (third step).

2. The fast reading training method as claimed in claim 1, further comprising the step of:
testing the fast reading ability of a fast reading trainee by adding a test mode on the fast reading menu picture, selecting the test mode by the trainee, outputting a fast reading test data to the connected terminal to measure the fast reading ability of the trainee and to store the tested result, and then returning to the selection menu of the second step (fourth step).

3. The fast reading training method as claimed in claim 1, wherein the connectable terminals are: client PCs for being connected through a wire Internet to the server 50; and wireless Internet terminals for being connected through a wireless Internet to the serve 50, such as hand phone, PCS, PDA, and IMT2000.

4. The fast reading training method as claimed in any one of claims 1 and 2, wherein the training data used in the fast reading training mode or in the test mode are stored in a nonvolatile storing device such as fresh memory, hard disk, MO, and rewritable CD,

5. The fast reading training method as claimed in claim 1, wherein the conditions for the fast reading training mode of the second step includes: an output method, an output speed, the number of outputs and an output time for the characters, images and motion pictures.

6. The fast reading training method as claimed in claim 1, wherein when displaying the fast reading training data at the third step, characters are sequentially outputted, reversed, deleted and blinked to induce motions of eyeballs.

7. The fast reading training method as claimed in claim 1, wherein when displaying the fast reading training data at the third step, images are sequentially outputted, reversed, deleted and blinked to induce motions of eyeballs.

8. The fast reading training method as claimed in claim 1, wherein when displaying the fast reading training data at the third step, motion pictures are outputted for a certain period of time to induce motions of eyeballs.

9. The fast reading training method as claimed in claim 8, wherein the output speed of the motion pictures is varied to induce motions of eyeballs.

10. The fast reading training method as claimed in claim 2, wherein at the test mode of the fourth step, (a) a particular training data is presented within a limited period of time, (b) the training data understanding level is measured, (c) if the user comes short of a certain required level, then the shifting time for the training data or the particular training data display time is increased, (d) the item c is repeated until the user reaches the required level, and (e) the fast reading ability of the user is assessed.

11. The fast reading training method as claimed in any one of claims 2 and 10, wherein a particular training data at the test mode consists of a text, an image or motion pictures.

12. A storing medium for storing a program comprising the functions of:
connecting one of connectable terminals by a fast reading trainee to a server to make the server transmit a fast reading menu picture data to the connectable terminal (first function);
outputting the fast reading menu picture onto a screen of the terminal, and selecting a fast reading training mode and fast reading training conditions by the fast reading trainee to receive them (second function); and
outputting the fast reading training data to the connectable terminal of the fast reading trainee to make the fasting reading trainee carry out the fast reading training based on the fast reading training mode and the fast reading training conditions as selected by the fast reading trainee (third function).

13. A storing medium for storing a program comprising the functions of:
connecting one of connectable terminals by a fast reading trainee to a server to make the server transmit a fast reading menu picture data to the connectable terminal (first function);
outputting the fast reading menu picture data onto a screen of the terminal, and selecting a fast reading training mode and fast reading training conditions by the fast reading trainee to receive them (second function);
outputting the fast reading training data to the connectable terminal of the fast reading trainee to make the fasting reading trainee carry out the fast reading training based on the fast reading training mode and the fast reading training conditions as selected by the fast reading trainee (third function); and
testing the fast reading ability of the fast reading trainee by adding a test mode on the fast reading menu picture, selecting the test mode by the trainee, outputting a fast reading test data to the connected terminal to measure the fast reading ability of the trainee and to store the tested result, and then returning to the selection menu of the second step (fourth function).

14. A fast reading training system utilizing an Internet communication network including at least one or more servers for providing particular services in response to requests by a plurality of connectable terminals, comprising: a wire communication module 51 for data transmission and reception through a wire Internet; a control module 52 for processing requests of connectable terminals upon receipt of them through the wire communication module 51, and for transmitting processed data to the connectable terminals, with a control program being stored in the control module 52; a fast reading training DB 53 for storing motion pictures, images and character data, and for outputting them upon requests by the control module 52; and a subscriber DB 55 for storing a set of private information including the fast reading training information on connected users.

15. A fast reading training system utilizing an Internet communication network including at least one or more servers for providing particular services in response to requests by a plurality of connectable terminals, comprising:
a wireless communication module 56 for data transmission and reception through a wireless Internet;
a gateway 54 for converting the signals transmitted and received to and from the wireless communication module 56;
a control module 52 for processing the requests of the connectable terminals upon receipt of them through the wireless communication module 56, and for transmitting the processed data to the connectable terminals, with a control program being stored in the control module;
a fast reading training DB 53 for storing motion pictures, images and character data, and for outputting them upon requests by the control module 52; and
a subscriber DB 55 for storing a set of private information including the fast reading training information on connected users.

16. The fast reading training system as claimed in any one of claims 14 and 15, wherein the fast reading training DB 53 and the subscriber DB 55 are nonvolatile storing devices such as fresh memory, hard disk, MO, and rewritable CD.

17. A fast reading evaluation method carried out on an offline basis, characterized in that:
(a) a particular training data is presented within a limited time;
(b) a training data understanding level is measured,
(c) if the user comes short of a certain required level, then a shifting time for the training data or a particular training data display time is increased,
(d) the item c is repeated until the user reaches the required level, and
(e) a fast reading ability of the user is assessed.

18. The fast reading evaluation method as claimed in claim 17, wherein the particular training data comprises: an output method, an output speed, the number of outputs and an output time for the characters, images and motion pictures.

19. The fast reading evaluation method as claimed in claim 17, wherein the output method for the particular training data is carried out by sequentially outputting, reversing, deleting and blinking the characters, images and motion pictures so as to induce motions of eyeballs.

20. A storing medium for storing a program to carry out the steps of: (a) presenting a particular training data within a limited time; (b) measuring a training data understanding level; (c) if the user comes short of a certain required level, then increasing a shifting time for the training data or a particular training data display time; (d) repeating the step c until the user reaches the required level, and (e) assessing a fast reading ability of the user.

21. The storing medium as claimed in claim 20, wherein the particular training data, its output method, its output speed, the number of times, and its output time are set up in advance in accordance with an ability of the fast reading trainee; and the particular training data consists of: characters, images, motion pictures or a combination of them.

22. The storing medium as claimed in claim 20, wherein the output method for the particular training data is carried out by sequentially outputting, reversing, deleting and blinking the characters, images and motion pictures so as to induce motions of eyeballs.
